(19) United States
(12) Patent Application Publication
(10) Pub. No.: US 2026/0366880 A1
(43) Pub. Date: Nov. 19, 2026

(54) MOVING BODY, ROUTE CHANGING METHOD, AND RECORDING MEDIUM

(71) Applicant: NEC Corporation, Tokyo (JP)

(72) Inventors: Masaaki TAKEUCHI, Tokyo (JP); Shintaro CHIKU, Tokyo (JP); Masanori KUKI, Tokyo (JP); Yoji OHNISHI, Tokyo (JP); Sawaka SEKI, Tokyo (JP)

(73) Assignee: NEC Corporation, Tokyo (JP)

(21) Appl. No.: 19/155,291

(22) PCT Filed: Feb. 20, 2023
(86) PCT No.: PCT/JP2023/005972

§ 371 Date: Aug. 11, 2025

(51) Int. Cl. G01C 21/34

(52) U.S. Cl. CPC G01C 21/3415

(57) ABSTRACT

Please delete the Abstract of the Disclosure, and replace it with the following: A moving body according to an aspect of the present disclosure moves along a preset route and includes: a camera, at least one memory storing instructions, and at least one processor configured to execute the instructions to: transmit an image captured with the camera to a predetermined transmission destination; acquire information indicating an operation state of a different monitoring system; and change the preset route based on the operation state of the different monitoring system.

### TECHNICAL FIELD

The present disclosure relates to a moving body, a moving body control device, a route changing method, and a recording medium.

### BACKGROUND ART

PTL 1 discloses an example of a monitoring device using a drone that sets a flight route based on computer aided design (CAD) information of a building. Further, the document describes that a server that sets a flight route for the drone can detect a sick or dead chicken early by setting flight timing based on feeding information that indicates the place and time of feeding.

PTL 2 discloses an example of a control device capable of quickly confirming occurrence of an abnormal state by searching for a moving body capable of appropriately capturing an image of the position at which the abnormality occurred.

### CITATION LIST

### Patent Literature

PTL 1: JP 2019-208197 A
PTL 2: JP 2019-179627 A

### SUMMARY OF INVENTION

### Technical Problem

The monitoring systems illustrated in PTL 1 and PTL 2 have a problem that the monitoring course cannot be changed in cooperation with a different monitoring system. For example, PTL 2 describes selecting a moving body capable of capturing an image of the position at which an abnormality occurred from a plurality of mobile bodies and instructing the selected moving body to capture the image. However, it does not describe any cooperative operation with a different monitoring system.

An object of the present disclosure is to provide a moving body, a moving body control device, a route changing method, and a recording medium capable of changing a movement route in cooperation with a different monitoring system.

### Solution to Problem

According to a first perspective, provided is a moving body including: a camera; a movement means for moving along a pre-set route; a transmission means that transmits an image captured with a camera to a predetermined transmission destination; an information acquisition means for acquiring information indicating the operation state of a different monitoring system; and a route changing means for changing the route based on the operation state of said other monitoring system.

According to a second perspective, provided is a moving body control device including: a setting means for configuring a moving body that transmits an image captured by a camera to a predetermined transmission destination with a route of the moving body; an information acquisition means for acquiring information indicating an operation state of a different monitoring system; and a route changing means for changing the route with which the moving body is configured, based on the operation state of the different monitoring system.

According to a third perspective, provided is a route changing method including: by a moving body that includes a camera, moves along a preset route, and transmits an image captured with the camera to a predetermined transmission destination, acquiring information indicating an operation state of a different monitoring system; and changing the route based on the operation state of the different monitoring system.

According to a fourth perspective, provided is a route changing method including: by a moving body control device that receives from a moving body that moves along a preset route an image captured with a camera included in the moving body, acquiring information indicating an operation state of a different monitoring system; and changing a route set to the moving body, based on the operation state of the different monitoring system.

According to a fifth perspective, provided is a recording medium storing a program that causes a computer attached to a moving body that includes a camera, moves along a preset route, and transmits an image captured with the camera to a predetermined transmission destination to execute: processing of acquiring information indicating an operation state of a different monitoring system; and processing of changing the route based on the operation state of the different monitoring system.

According to a sixth perspective, provided is a recording medium storing a program that causes a computer attached to a moving body control device that receives from a moving body that moves along a preset route an image captured with a camera included in the moving body to execute: processing of acquiring information indicating an operation state of a different monitoring system; and processing of changing a route set to the moving body, based on the operation state of the different monitoring system.

### Advantageous Effects of Invention

According to the present disclosure, a moving body, a moving body control device, a route changing method, and a recording medium capable of changing a movement route in cooperation with a different monitoring system are provided.

### BRIEF DESCRIPTION OF DRAWINGS

FIG. 1 is a diagram illustrating a configuration of one example embodiment of the present disclosure.

FIG. 2 is a flowchart illustrating an operation of one example embodiment of the present disclosure.

FIG. 3 is another diagram illustrating a configuration of one example embodiment of the present disclosure.

FIG. 4 is a block diagram illustrating a configuration of an automated vehicle according to the first example embodiment of the present disclosure.

FIG. 5 is a flow diagram illustrating an operation of the automated vehicle according to the first example embodiment of the present disclosure.

FIG. 6 is a diagram for describing a route changing operation of an automated vehicle according to the first example embodiment of the present disclosure.

FIG. 7 is another diagram for describing a route changing operation of an automated vehicle according to the first example embodiment of the present disclosure.

FIG. 8 is a block diagram illustrating a configuration of an automated vehicle according to the second example embodiment of the present disclosure.

FIG. 9 is a diagram for describing a route changing operation of an automated vehicle according to the second example embodiment of the present disclosure.

FIG. 10 is a functional block diagram illustrating the configuration of the control center device of the third example embodiment of the present disclosure.

FIG. 11 is a flow diagram illustrating an operation of the control center device according to the third example embodiment of the present disclosure.

FIG. 12 is a diagram for describing a route changing operation of a moving body according to the fourth example embodiment of the present disclosure.

FIG. 13 is a diagram for describing a further example modification of the fourth example embodiment of the present disclosure.

FIG. 14 is a diagram illustrating the configuration of a computer that can function as the moving body or the control center device of the present disclosure.

### EXAMPLE EMBODIMENT

An outline of an example embodiment of the present disclosure will be described with reference to the drawings. The reference numerals in the drawings attached to this outline are attached to each element for convenience as an example for assisting understanding, and are not intended to limit the present disclosure to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although there are ports and interfaces at connection points of input and output of each block in the drawing, they are not illustrated.

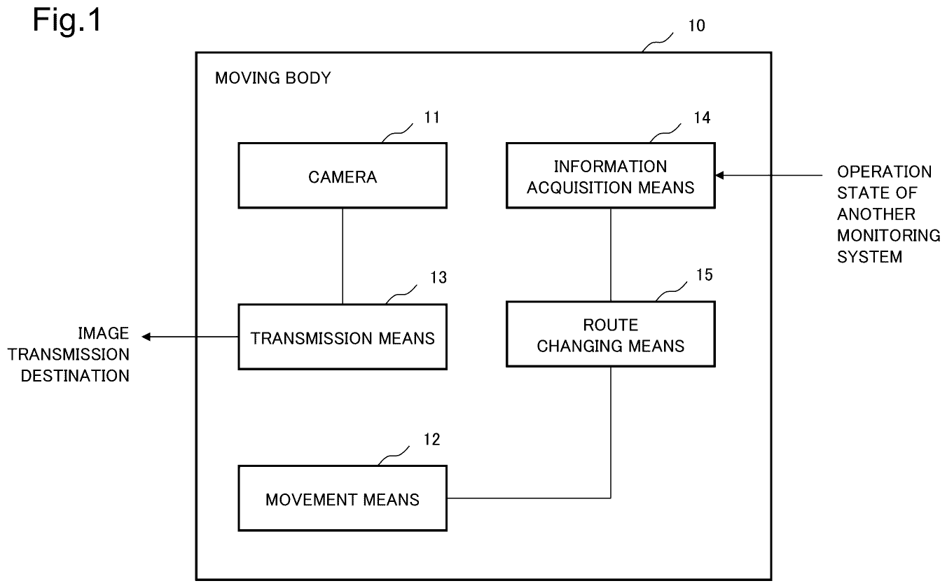

In an example embodiment thereof, as illustrated in FIG. 1, the present disclosure can be achieved by a moving body 10 including a camera 11, a movement means 12, a transmission means 13, an information acquisition means 14, and a route changing means 15.

More specifically, the movement means 12 includes various propulsion devices that function as a movement means for the moving body to move along a preset route, and a control device that controls the propulsion devices.

The transmission means 13 transmits the image captured with the camera 11 to a predetermined transmission destination. The camera 11, the movement means 12, and the transmission means 13 may be those used in unmanned aerial vehicles (UAVs) called drones or automated vehicles.

The information acquisition means 14 acquires information indicating an operation state of a different monitoring system. Examples of the information indicating the operation state of a different monitoring system include, but are not limited to, the patrol route and patrol schedule of a security vehicle forming part of the security system. For example, the operation state of a monitoring camera system or the like may be acquired as the operation state of a different monitoring system. Information indicating the operation state of a different monitoring system may be acquired from, for example, a different monitoring system deployed on a cloud computing infrastructure via a wireless network.

The route changing means 15 changes the route of the moving body 10 based on the operation state of the different monitoring system.

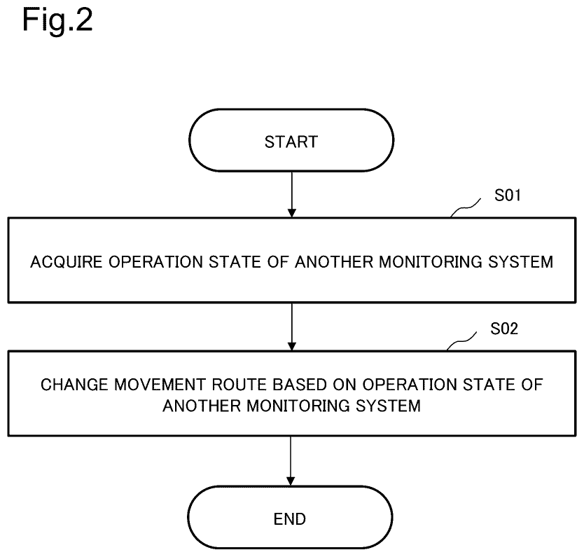

FIG. 2 illustrates a route changing method. As illustrated in FIG. 2, the moving body 10 configured as described above acquires information indicating an operation state of a different monitoring system (step S01), and changes a route of the moving body 10 based on the operation state of the different monitoring system (step S02).

In the step S02, the moving body 10 changes the route to a route that complements the monitoring capability of the different monitoring system based on the operation state of the different monitoring system. For example, when the different monitoring system is in a sleeping state, the moving body 10 performs an operation of including a monitoring area of the different monitoring system in the route, and transmits the captured image to a predetermined transmission destination. For example, in a case where the different monitoring system has sufficient monitoring capability, the moving body 10 performs an operation of removing the monitoring area of the different monitoring system from the route. As a result, the moving body 10 can focus on patrol and image capturing of places that cannot be monitored by other monitoring systems.

According to the moving body 10 that operates as described above, it is possible to construct a remote monitoring system capable of changing a monitoring area in cooperation with a different monitoring system.

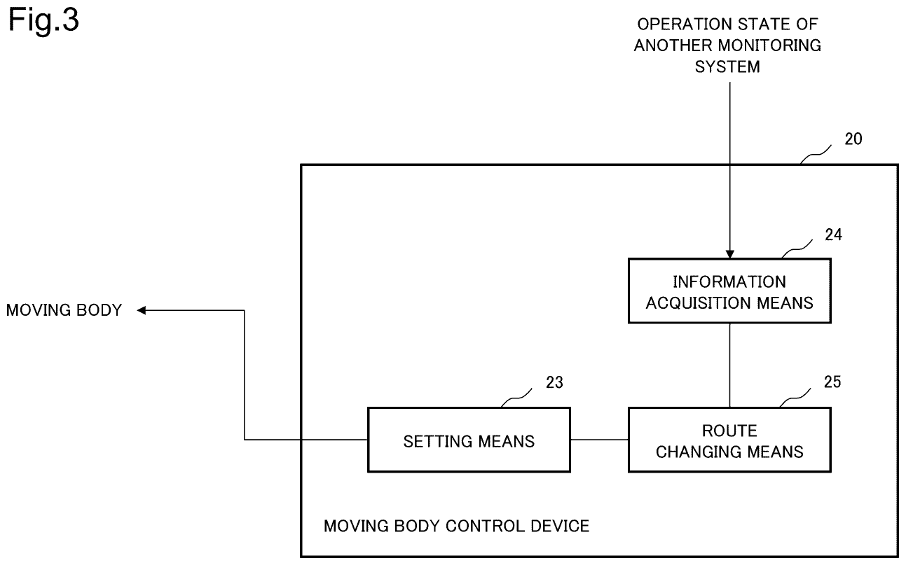

Although FIGS. 1 and 2 describe an example in which the information acquisition means 14 and the route changing means 15 are provided on the moving body 10 side, these functions may be arranged on a moving body control device side that controls the route of the moving body. FIG. 3 is another diagram illustrating a configuration of one example embodiment of the present disclosure.

Referring to FIG. 3, a moving body control device 20 including a setting means 23, an information acquisition means 24, and a route changing means 25 is illustrated. The setting means 23 configures the mobile object that transmits the image captured by the camera to a predetermined transmission destination with the route of the moving body.

The information acquisition means 24 acquires information indicating an operation state of a different monitoring system. Then, the route changing means 25 changes the set route of the moving body based on the operation state of the different monitoring system.

As illustrated in FIG. 2, the moving body control device 20 configured as described above acquires information indicating an operation state of a different monitoring system (step S01), and changes a route of the moving body 10 based on the operation state of the different monitoring system (step S02).

The moving body control device 20 that operates as described above also makes it possible to construct a remote monitoring system capable of changing a monitoring area in cooperation with a different monitoring system.

The different monitoring system described above may be a monitoring system that performs monitoring by a second moving body carrying a person. In that case, it is preferable that the route changing means 15 or 25 of the first or second examples described above perform an operation of changing the route to a second route that covers a location that cannot be monitored by the second moving body for patrol, based on the route of the second moving body acquired from the information acquisition means 14 or 24. This makes it possible to cause the moving body 10 to perform monitoring that covers a location where monitoring by a different monitoring system is likely to be insufficient.

### First Example Embodiment

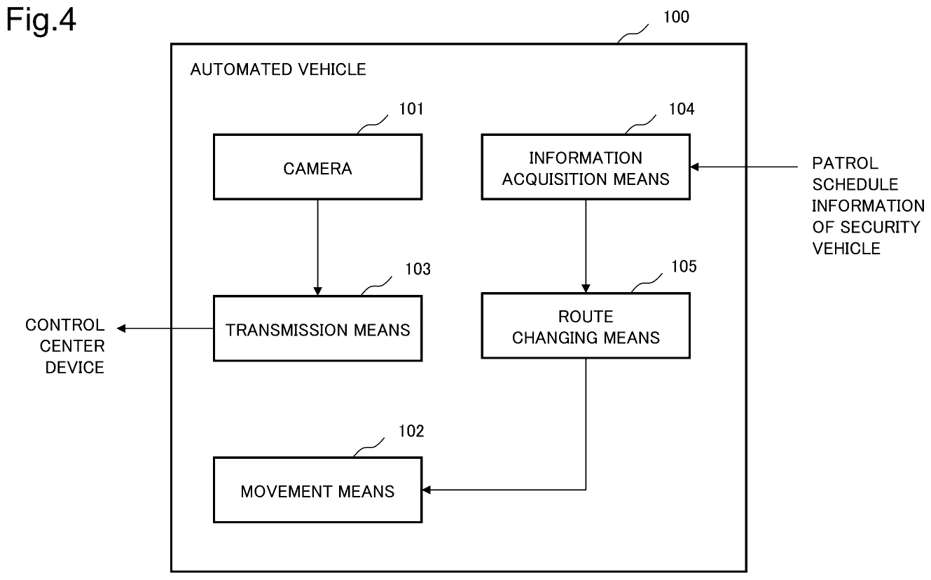

Next, a first example embodiment in which a cooperative operation function based on an operation state of a different monitoring system is added to an automated vehicle that moves autonomously and transmits an image to a control center device will be described in detail with reference to the drawings. In the following description, it is assumed that patrol schedule information of a security vehicle is used as a different monitoring system. FIG. 4 is a block diagram illustrating a configuration of an automated vehicle 100 according to the first example embodiment of the present disclosure.

Referring to FIG. 4, the illustrated automated vehicle 100 includes a camera 101, a movement means 102, a transmission means 103, an information acquisition means 104, and a route changing means 105.

The movement means 102 is a means for the automated vehicle 100 to move along a preset route. Specifically, it includes a plurality of wheels, a motor that drives the wheels, a control device, and the like.

The transmission means 103 transmits an image captured with the camera 101 to the control center device.

The information acquisition means 104 acquires patrol schedule information of the security vehicle from an external terminal or the like that manages the security vehicle. In the following description, it is assumed that the patrol schedule information of the security vehicle includes a patrol route, a patrol schedule, and the like of the security vehicle. Other than a police vehicle, examples of the security vehicle include various vehicles that perform monitoring work, such as a vehicle of a security company and a vehicle for inspection work.

The route changing means 105 creates a route that complements the monitoring area of the security vehicle based on the patrol schedule information situation of the security vehicle, and configures the movement means 102 with the route.

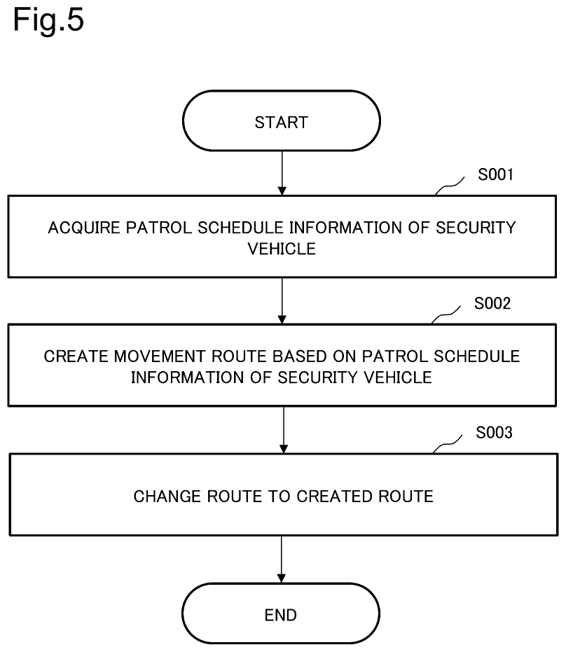

Next, the operation of the present example embodiment will be described in detail with reference to the drawings. FIG. 5 is a flow diagram illustrating an operation of the automated vehicle 100 according to the first example embodiment of the present disclosure. Referring to FIG. 5, the automated vehicle 100 acquires the patrol schedule information of the security vehicle from an external terminal or the like that manages the security vehicle (step S001).

Then, the automated vehicle 100 creates a route that complements the monitoring area of the security vehicle based on the patrol schedule information situation of the security vehicle (step S002). It is also possible that, every time the route changing means 105 creates a route, it creates a route that covers a specific point for patrol obtained from the schedule information of the security vehicle. As another method of creating a route, the route changing means 105 may select a route that meets a condition from a plurality of routes created in advance.

Next, the automated vehicle 100 sets the created route to the movement means 102 and changes the changed route (step S003).

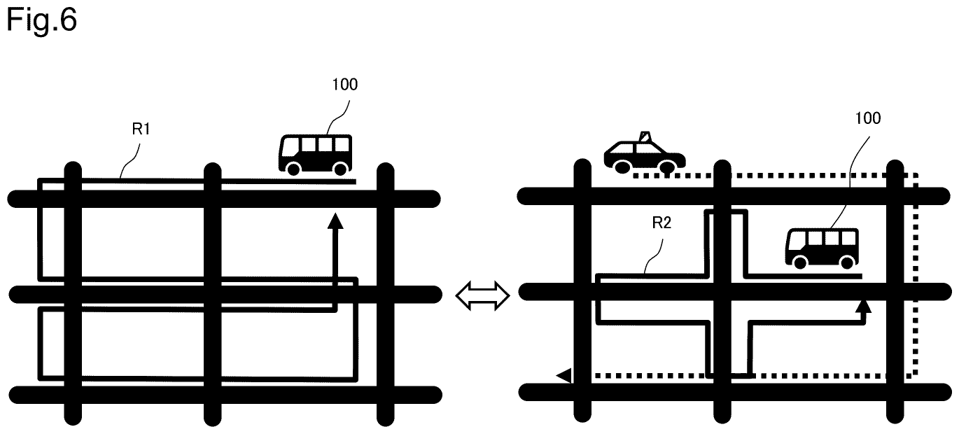

FIG. 6 is a diagram for explaining a route changing operation of the automated vehicle 100 of the present disclosure. The diagram on the left side of FIG. 6 illustrates a patrol route R1 of the automated vehicle 100 when the security vehicle is not patrolling as a result of acquiring the patrol schedule information of the security vehicle. In a state where the security vehicle is not patrolling, in order to monitor the entire illustrated area, the automated vehicle 100 creates the figure-eight-shaped patrol route R1 so as to cover the entire area, and moves along it.

The diagram on the right side of FIG. 6 illustrates a patrol route of the automated vehicle 100 when the security vehicle is patrolling. In a state where the security vehicle is patrolling, the automated vehicle 100 creates a plus-shaped patrol route R2 so as to cover a section indicated by a broken line that the security vehicle does not patrol, and moves along it. Therefore, the automated vehicle 100 switches the patrol route in consideration of the operation state of the security vehicle, whereby the area illustrated in FIG. 6 can be efficiently monitored.

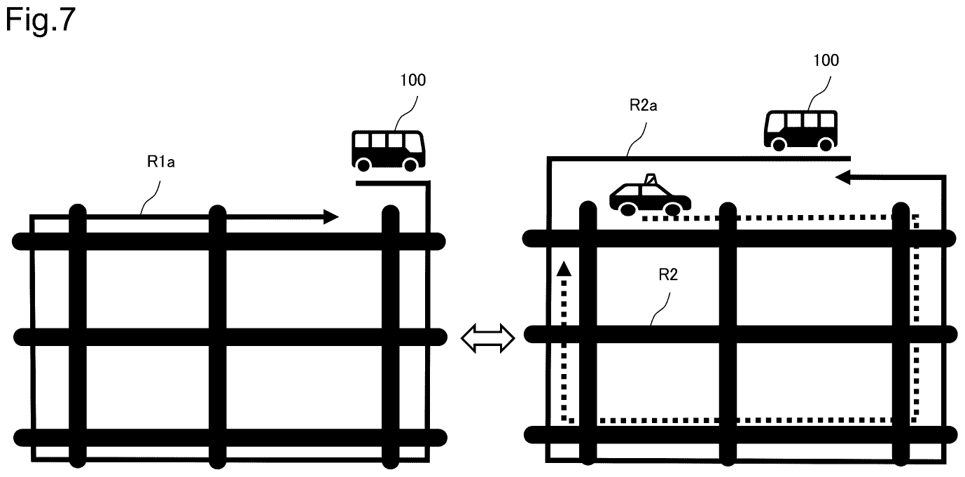

FIG. 7 is another diagram for explaining the route changing operation of the automated vehicle 100 of the present disclosure. The diagram on the left side of FIG. 7 illustrates a patrol route R1a of the automated vehicle 100 when the security vehicle is not patrolling as a result of acquiring the patrol schedule information of the security vehicle. In a state where the security vehicle is not patrolling, the automated vehicle 100 creates a patrol route R1a that circles the periphery of the designated area clockwise, and moves along it.

The diagram on the right side of FIG. 7 illustrates a patrol route of the automated vehicle 100 when the security vehicle is patrolling. In a state where the security vehicle is patrolling, the automated vehicle 100 creates a patrol route R2a that follows the same path as the route of the security vehicle indicated by a broken line but in the opposite direction, and moves along it. By moving along a route in a direction opposite to that of the security vehicle as in this example, it is possible to exhaustively capture images of vehicles and people on the road that cannot be grasped by the security vehicle.

FIGS. 6 and 7 describes examples in which the automated vehicle 100 switches its route between the two patrol routes R1 and R2 or R1a and R2a. However, the mode of switching the patrol route by the automated vehicle 100 is not limited to the examples shown in FIGS. 6 and 7. For example, when the security vehicle has a plurality of patterns of patrol routes, the automated vehicle 100 may move along a patrol route corresponding to these different patrol routes.

Further, the frequency of acquisition of the patrol schedule information of the security vehicle by the automated vehicle 100 may be about every several hours. However, by reducing the intervals, the automated vehicle 100 can respond to emergency events. For example, there is a case where the security vehicle finds an incident or an accident while patrolling, and stops patrolling. In such a case, by causing the automated vehicle 100 to acquire the patrol schedule information of the security vehicle, it is possible to switch from the patrol route R2 on the right side of FIG. 6 to the patrol route R1 on the left side of FIG. 6 so that it performs patrol in place of the security vehicle.

Further, when the automated vehicle 100 creates a patrol route, it may create the patrol route taking into consideration, for example, traffic rules applied to the security vehicle. For example, a security vehicle cannot patrol a pedestrian-only area where entry of a vehicle is prohibited. In this case, a route for enhancing the monitoring of the pedestrian-only area may be created using an automated vehicle 100 that can travel on the sidewalk. For example, a security vehicle cannot patrol a one-way road in the opposite direction. In this case, the automated vehicle 100 to which traffic rules for vehicles is not applied may be caused to create a route that moves along the one-way road in the opposite direction. In this way, the security vehicle can be informed of a person or a vehicle in a pedestrian-only area or on a one-way road that its monitoring area cannot cover.

### Second Example Embodiment

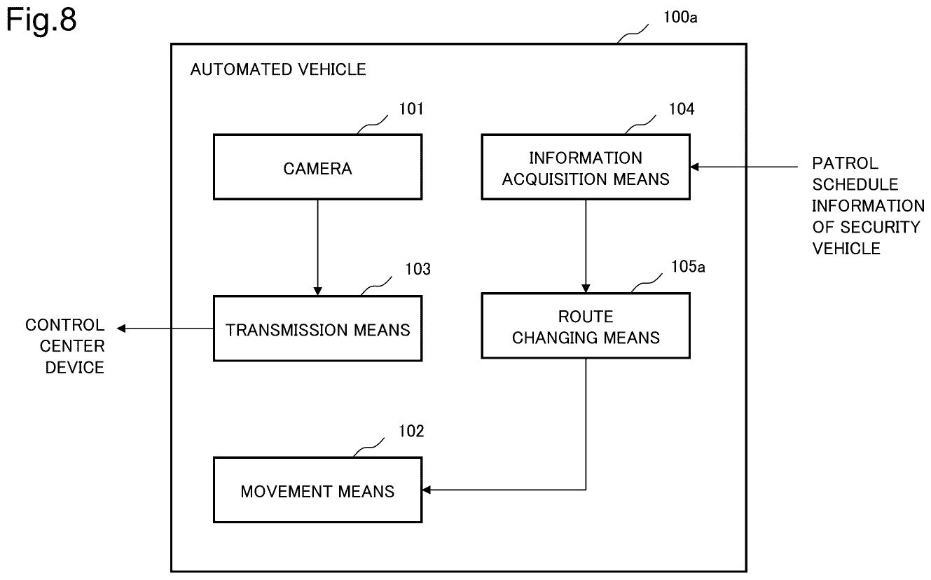

Next, a second example embodiment in which a route changing function that takes into consideration a part of the day and/or a day of the week is added to the automated vehicle 100 will be described in detail with reference to the drawings. FIG. 8 is a functional block diagram illustrating the configuration of an automated vehicle 100a of the second example embodiment of the present disclosure. A difference from the first example embodiment illustrated in FIG. 4 is that the route changing function that takes into consideration the part of the day and/or day of the week is added to a route changing means 105a of an automated vehicle 100a. Since other configurations are similar to those of the first example embodiment, description thereof will be omitted, and differences will be mainly described below.

The route changing means 105a of the present example embodiment holds a plurality of patterns of patrol routes, selects a patrol route from these patrol routes according to the part of the day and/or day of the week, and configures the movement means 102 with the selected patrol route.

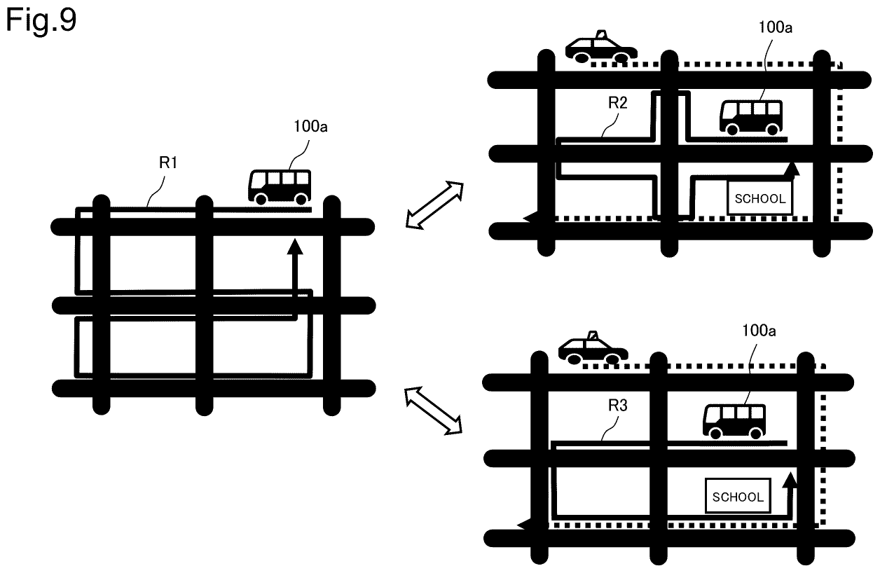

FIG. 9 is a diagram for describing a route changing operation of a moving body according to the second example embodiment of the present disclosure. The diagram on the left side of FIG. 9 illustrates the patrol route R1 of the automated vehicle 100a when the security vehicle is not patrolling, which is the same as that illustrated on the left side of FIG. 6. On the other hand, the two upper and lower drawings on the right side of FIG. 9 illustrate patrol routes that are selectively used by the automated vehicle 100a based on the part of the day and/or day of the week when the security vehicle is patrolling.

For example, in a case where it is currently daytime on a weekday, the automated vehicle 100a selects the patrol route on the upper right of FIG. 9 from the patrol routes illustrated on the right side of FIG. 9, and moves along the selected route. In a case where it is currently the morning or evening of a weekday, the automated vehicle 100a selects a patrol route R3 on the lower right of FIG. 9 from the patrol routes illustrated on the right side of FIG. 9, and moves along the selected route. In this way, the automated vehicle 100a can watch over children on their way to and from school. In particular, in the patrol route R3 of FIG. 9, the automated vehicle 100a is set to travel in a direction opposite to the security vehicle. In this way, the security vehicle and the automated vehicle 100a can perform monitoring in such a way that they each pass by children and other people who goes in and out of school.

Needless to say, the example of FIG. 9 is an example for describing the present disclosure, and the present invention is not limited to the switching of patrol routes illustrated in FIG. 9. For example, in the example of FIG. 9, the automated vehicle 100a selects the patrol route R1 when the security vehicle is not patrolling; however, even when the security vehicle is not patrolling, the automated vehicle 100a may select the patrol route according to the current time and/or day of the week from a plurality of routes.

In addition, in the present example embodiment, it has been described that the route changing means 105a holds a plurality of patterns of routes, and selects a patrol route from these routes according to the part of the day and/or day of the week. However, it is also possible to adopt a mode in which the route changing means 105a creates a patrol route each time. In this case, the route changing means 105a changes a creation rule of the patrol route according to the part of the day and/or day of the week to switch the patrol route.

Further, although FIG. 9 describes an example of switching the patrol route from the viewpoint of capturing images of children and other people who go in and out of school, the patrol route may be changed from other viewpoints. For example, in a case where there is an area where incidents or accidents frequently occur, a patrol route may be set so as to enhance patrol during a time incidents or accidents frequently occur. In addition, for example, in a case where there is an area where the pedestrian traffic increases depending on the time, a patrol route may be set so as to enhance patrol during a time the pedestrian traffic increases.

### Third Example Embodiment

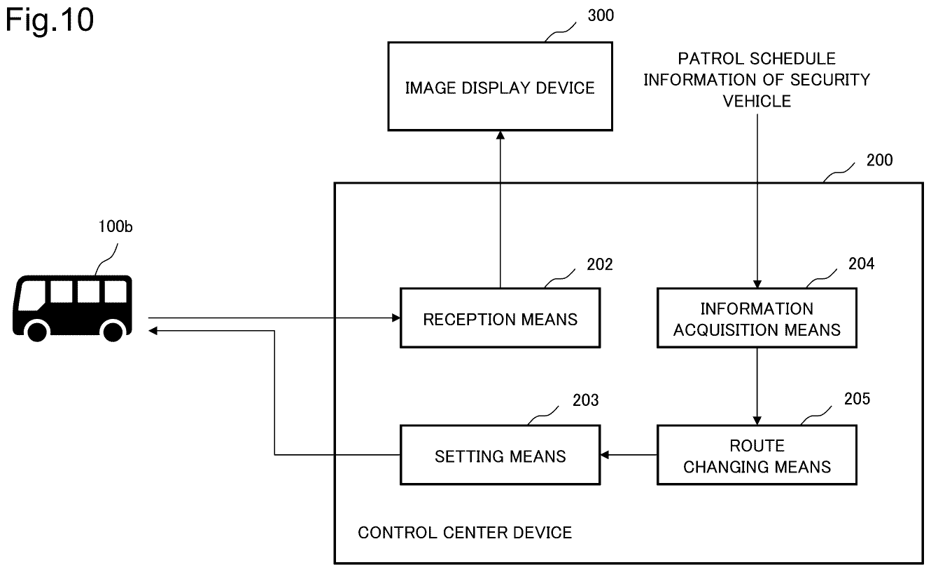

Next, a third example embodiment in which a function of changing a patrol route based on an operation state of a security vehicle is located in a control center device (corresponding to the moving body control device) that controls the route of an automated vehicle 100b will be described in detail with reference to the drawings. FIG. 10 is a block diagram illustrating a configuration of the control center device according to the third example embodiment of the present disclosure.

Referring to FIG. 10, a control center device 200 including a reception mean 202, a setting means 203, an information acquisition means 204, and a route changing means 205 is illustrated. The reception means 202 receives a captured image from the automated vehicle 100b, and sends the received captured image to an image display device 300. A member of the control center in charge performs a control operation with reference to information displayed on the image display device 300.

The setting means 203 sets a patrol route for the automated vehicle 100b.

The information acquisition means 204 acquires patrol schedule information of the security vehicle from an external terminal or the like that manages the security vehicle.

The route changing means 205 creates a route that complements the monitoring area of the security vehicle based on the patrol schedule information situation of the security vehicle, and instructs the setting means 203 to configure the automated vehicle 100b with the route.

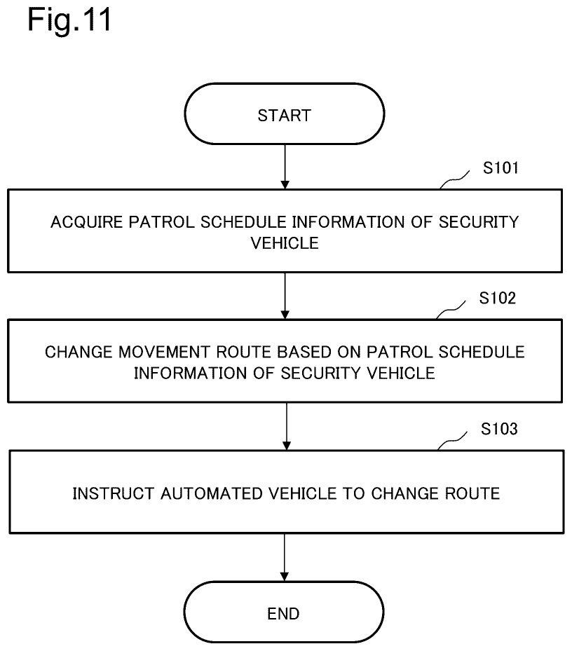

Next, the operation of the present example embodiment will be described in detail with reference to the drawings. FIG. 11 is a flow diagram illustrating an operation of the control center device 200 according to the third example embodiment of the present disclosure. Referring to FIG. 11, the control center device 200 acquires the patrol schedule information of the security vehicle from an external terminal or the like that manages the security vehicle (step S101).

Then, the control center device 200 creates a patrol route that complements the monitoring area of the security vehicle based on the patrol schedule information situation of the security vehicle (step S202). Note that, as in the first and second example embodiments, the creation of a patrol route can be performed by adopting a method in which the route changing means 205 creates a route that covers a specific point for patrol each time, or a method in which a patrol route that meets a condition is selected from a plurality of routes created in advance.

Next, the control center device 200 instructs the setting means 203 to set the created patrol route, and instructs movement along the changed route (step S203).

Also in the present example embodiment, it is possible to achieve switching of patrol routes according to the operation state of the security vehicle as illustrated in FIGS. 6 and 7. In addition, similarly to the second embodiment, the present example embodiment can change the patrol route according to the part of the day and/or day of the week (see FIG. 9), in addition to the operation state of the security vehicle. Furthermore, in the present example embodiment, since a function of the automated vehicle 100b itself can be omitted, the introduction cost can be reduced.

### Fourth Example Embodiment

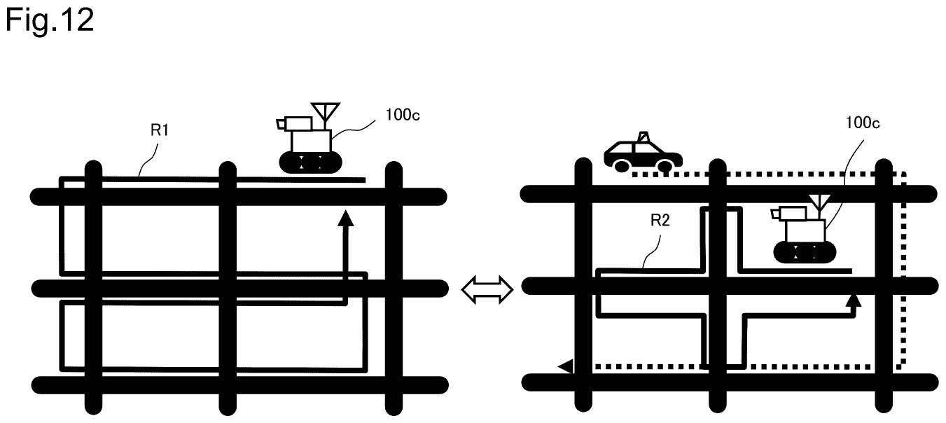

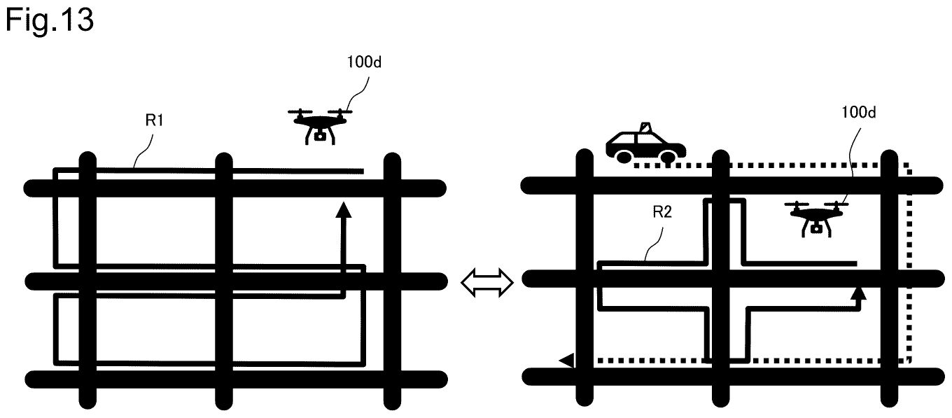

The first to third embodiments described above describe examples in which the moving body is an automated vehicle; however, the moving body to which the present disclosure can be applied is not limited to an automated vehicle. For example, the present disclosure can also be applied to a transporting device, a robot, or the like that travels along a route in a designated area. In that case, as illustrated by a robot 100c in FIG. 12, these devices change their routes based on the operation state of a different monitoring system. For example, the present disclosure can also be applied to a drone or the like that flies along a route in a designated area. In that case, as illustrated by a drone 100d in FIG. 13, these devices change their routes based on the operation state of a different monitoring system.

### Hardware Configuration

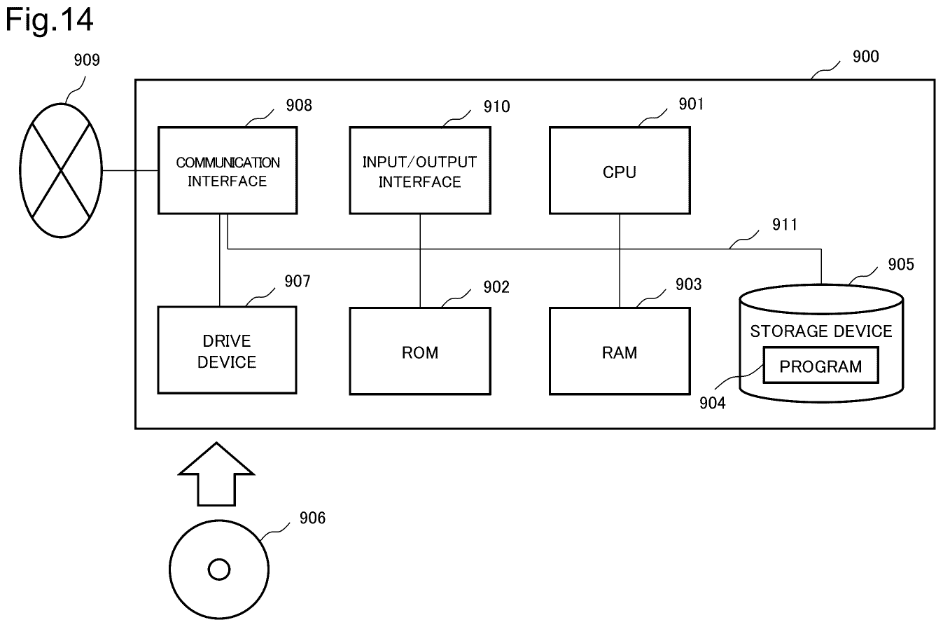

In each example embodiment of the present disclosure, each component of each device indicates a block of a functional unit. Part or all of each component of each device is achieved by, for example, an any combination of an information processing device 900 and a program as illustrated in FIG. 14. FIG. 14 is a block diagram illustrating an example of a hardware configuration of the information processing device 900 that achieves each component of each device. The information processing device 900 includes the following configuration as an example.
CPU(Central Processing Unit) 901
ROM(Read Only Memory) 902
RAM(Random Access Memory) 903
Program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting respective components

Each component of each device in each example embodiment is achieved by the CPU 901 acquiring and executing a program 904 for achieving these functions. That is, the CPU 901 of FIG. 14 may execute a program for changing the route based on a program for acquiring information indicating an operating state of a different monitoring system or based on the operating state of the different monitoring system, and perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) storage medium.

There are various modifications of the implementation method of each device. For example, each device may be achieved by any combination of the information processing device 900 and the program separate for each component. A plurality of components included in each device may be achieved by any combination of one information processing device 900 and a program. That is, the present invention can be achieved by a computer program that causes a processor mounted in each of the devices described in the first to fifth example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

The first to third example embodiments described above can be made into different example embodiments by combining the features.

For example, the automated vehicles of the first and second example embodiments and an automated vehicle controlled by the control center device of the third embodiment can coexist.

Some or all of the above example embodiments may be described as the following Supplementary Notes, but are not limited to the following.

### Supplementary Note 1

A moving body comprising:
a camera;
a movement means for moving along a preset route;
a transmission means for transmitting an image captured with the camera to a predetermined transmission destination;
an information acquisition means for acquiring information indicating an operation state of a different monitoring system; and
a route changing means for changing the route based on the operation state of the different monitoring system.

### Supplementary Note 2

The route changing means of the moving body can adopt a configuration of selecting a route based on a part of the day or a day of the week from a plurality of routes set in advance.

### Supplementary Note 3

The different monitoring system is a monitoring system that performs monitoring by a second moving body carrying a person, and
the route changing means of the moving body can adopt a configuration of changing the route to a second route for patrolling a location that cannot be monitored by the second moving body, based on a route of the second moving body acquired from the information acquisition means.

### Supplementary Note 4

The moving body can adopt a configuration of setting a route for monitoring a pedestrian-only area or a route for moving along a one-way road in an opposite direction as the second route.

### Supplementary Note 5

A moving body control device comprising:
a setting means for configuring a moving body that transmits an image captured by a camera to a predetermined transmission destination with a route of the moving body;
an information acquisition means for acquiring information indicating an operation state of a different monitoring system; and
a route changing means for changing the route with which the moving body is configured, based on the operation state of the different monitoring system.

### Supplementary Note 6

The route changing means of the moving body control device can adopt a configuration of selecting a route based on a part of the day or a day of the week from a plurality of routes set in advance.

### Supplementary Note 7

The different monitoring system is a monitoring system that performs monitoring by a second moving body carrying a person, and
the route changing means of the moving body control device can adopt a configuration of changing the route to a second route for patrolling a location that cannot be monitored by the second moving body, based on a route of the second moving body acquired from the information acquisition means.

### Supplementary Note 8

The moving body control device can adopt a configuration of setting a route for monitoring a pedestrian-only area or a route for moving along a one-way road in an opposite direction or a forward direction is set as the second route.

### Supplementary Note 9

A route changing method comprising:
by a moving body that includes a camera, moves along a preset route, and transmits an image captured with the camera to a predetermined transmission destination,
acquiring information indicating an operation state of a different monitoring system; and
changing the route based on the operation state of the different monitoring system.

### Supplementary Note 10

A route changing method comprising:
by a moving body control device that receives from a moving body that moves along a preset route an image captured with a camera included in the moving body,
acquiring information indicating an operation state of a different monitoring system;
changing a route with which the moving body is configured, based on the operation state of the different monitoring system; and
set the route to the moving body.

### Supplementary Note 11

A recording medium storing a program that causes
a computer attached to a moving body that includes a camera, moves along a preset route, and transmits an image captured with the camera to a predetermined transmission destination to execute:
processing of acquiring information indicating an operation state of a different monitoring system; and
processing of changing the route based on the operation state of the different monitoring system.

### Supplementary Note 12

A recording medium storing a program that causes
a computer attached to a moving body control device that receives from a moving body that moves along a preset route an image captured with a camera included in the moving body to execute:
processing of acquiring information indicating an operation state of a different monitoring system; and
processing of changing a route set to the moving body, based on the operation state of the different monitoring system.

The forms of the Supplementary Notes 9 to 12 can be expanded to the forms of the Supplementary Notes 2 to 4, similarly to the Supplementary Note 1.

The disclosure of the above PTL is incorporated herein by reference, and can be used as a basis or part of the present disclosure as necessary. Within the frame of the entire disclosure (including the claims) set forth herein, it is possible to change and adjust the example embodiments or examples further based on of the basic technical idea thereof. Various combinations or selections (including partial deletions) of various disclosure elements (each element of each claim, each element of each example embodiment or example, each element of each drawing, and the like are included) can be made within the frame of the disclosure set forth herein. That is, it is a matter of course that the present disclosure includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present specification according to the gist of the present disclosure as necessary is included in the matters disclosed in the present application.

### REFERENCE SIGNS LIST

10 moving body
11,101 camera
12, 102 movement means
13, 103 transmission means
14, 104 information acquisition means
15, 105 route changing means
20 moving body control device
23, 203 setting means
24, 204 information acquisition means
25, 205 route changing means
100, 100a, 100b automated vehicle
100c robot
100d drone
101 camera
102 movement means
103 transmission means
104 information acquisition means
105, 105a route changing means
202 reception means
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input/output interface
911 bus
R1, R2, R1a, R2a, R3 patrol route

What is claimed is:

1. A moving body that moves along a preset route, the moving body comprising:
a camera;
at least one memory storing instructions; and
at least one processor configured to execute the instructions to:
transmit an image captured with the camera to a predetermined transmission destination;
acquire information indicating an operation state of a different monitoring system; and
change the preset route based on the operation state of the different monitoring system.

2. The moving body according to claim 1, wherein the at least one processor is further configured to execute the instructions to:
select a route based on a part of the day or a day of the week from a plurality of routes set in advance.

3. The moving body according to claim 1, wherein
the different monitoring system is a monitoring system that performs monitoring by a second moving body carrying a person, and wherein the at least one processor is further configured to execute the instructions to:
acquire, as information indicating the operation state of the different monitoring system, a route of the second moving body;
change the preset route to a second route for patrolling a location that cannot be monitored by the second moving body, based on the route of the second moving body acquired.

4. The moving body according to claim 3, wherein
the moving body sets a route for monitoring a pedestrian-only area or a route for moving along a one-way road in an opposite direction as the second route.

5. The moving body according to claim 3, wherein
the moving body sets a route that follows the same path as the route of the second moving body but in an opposite direction as the second route.

6.-11. (canceled)

12. A route changing method comprising:
by a moving body control device that receives from a moving body that moves along a preset route an image captured with a camera included in the moving body,
acquiring information indicating an operation state of a different monitoring system; and
changing a route set to the moving body, based on the operation state of the different monitoring system.

13. (canceled)

14. A non-transitory recording medium storing a program that causes
a computer attached to a moving body control device that receives from a moving body that moves along a preset route an image captured with a camera included in the moving body to execute:
processing of acquiring information indicating an operation state of a different monitoring system; and
processing of changing a route set to the moving body, based on the operation state of the different monitoring system.
